(19) United States
(12) Patent Application Publication
(10) Pub. No.: US 2006/0036037 A1
(43) Pub. Date: Feb. 16, 2006

(54) Thermoplastic molding compositions

(75) Inventors: Martin Weber, Maikammer (DE); Bernd Bruchmann, Freinsheim (DE); Hideko Oyama, Oota-ku (JP); Takashi Inoue, Yamagata (JP); Toshiaki Ougizawa, Ibaraki (JP); Tomoki Kitagawa, Aichii (JP)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/539,957

(22) PCT Filed: Dec. 13, 2003
(86) PCT No.: PCT/EP03/14196

§ 371 Date: Jun. 17, 2005

(30) Foreign Application Priority Data
Dec. 17, 2002 (DE) 102 59 266.7

(51) Int. Cl. C08L 67/02; C08L 77/00

(52) U.S. Cl. 525/165; 525/178

(57) ABSTRACT

Thermoplastic molding compositions, comprising: A) at least one rubber-free copolymer in which no hydroxyl group, acid group, amino group, or anhydride group is present, based on at least one vinylaromatic monomer (a1) and at least one comonomer (a2), B) at least one rubber-free polymer in which at least one hydroxyl group, acid group, or amidno group is present, C) from 3 to 50% by weight, based on the total weight of the molding composition, of at least one rubber, D) at least one terpolymer, C)obtainable from d1) at least one vinylaromatic monomer, d2) at least one C₁-C₄-alkyl (meth)acrylate or (meth)acrylonitrile, and d3) from 0.4 to 4% by weight, based on the total weight of the teruolymer, of at least one monomer in which an αβ-unsaturatedl anhydride is present, and E) at least one compound having at least two isocyanate groups.

The present invention relates to thermoplastic molding compositions which comprise
A) at least one rubber-free copolymer in which no hydroxyl group, acid group, amino group, or anhydride group Is present, based on at least one vinylaromatic monomer (a1) and at least one copolymer (a2),
B) at least one rubber-free polymer in which at least one hydroxyl group, acid group, or amino group is present,
C) from 3 to 50% by weight, based on the total weight of components A to E, of at least one rubber,
D) at least one terpolymer, obtainable from
   d1) at least one vinylaromatic monomer,
   d2) at least one C₁-C₄-alkyl (meth)acrylate or (meth)acrylonitrile, and
   d3) from 0.4 to 4% by weight, based on the total weight of components d1) to d3), of at least one monomer in which an ao-unsaturated anhydride is present, and
E) at least one compound having at least two isocyanate groups.

The present invention further relates to the use of the thermoplastic molding compositions for producing moldings, films, or fibers, and also to the moldings, films, or fibers obtainable using the thermoplastic molding compositions. The present invention also relates to a process for improving the compatibility of molding compositions, and to a means of improving the compatibility of molding compositions. Preferred embodiments are found in the subclaims and in the description. It goes without saying that preferred embodiments are also understood as being any combination of any preferred embodiment in any of the components with any preferred embodiment in any of the other components.

It is known per se that materials with a particular property profile can be produced by combing different polymers which are immiscible or only partially miscible with one another. It is also known that the compatibility of the phases, and therefore the mechanical properties of the molding compositions, can be improved by adding compounds which can react with the polymers of one or all of the phases present in the blend.

The approach often used here has been to functionalize one of the actual phases, for example the rubber, and to make it reactive toward the other phase and a compatibilizer. For example, the Japanese laid-open specification JP 11-166116 prepares a graft rubber having functional groups and mixes this with a mixture of two polyesters, polybutylene terephthalate and polycaprolactone, with concomitant use of an isocyanate.

However, a disadvantage of these molding compositions is that specific complicated syntheses first have to be used to prepare the rubbers. U.S. Pat. No. 4,902,749 discloses that a modified styrene polymer having functional groups which can react with hydroxyl groups or with amino groups, where these functional groups include anhydride groups or isocyanate groups, can be used concomitantly in a molding composition composed of polyamide and of a rubber.

Molding compositions composed of polyamide and of a rubber and comprising functionalized terpolymers, e.g. of styrene, acrylonitrile, and maleic anhydride, as compatibilizer are known, as described in EP-A 784 080. Although these molding compositions have good impact strength their values for tensile strain at break are inadequate for some applications.

Ju and Chang (Polymer 41(2000) 1719-1730) describe rubber-free molding compositions based on polyethylene terephthalate and polystyrene and styrene-maleic anhydride copolymer, and also poly[methylene(phenylene isocyanate)] (PMPI) as compatibilizer. These molding compositions are too brittle for many applications. In addition, the miscibility of the styrene-maleic anhydride copolymers with many polymers is inadequate to bring about a decisive improvement in properties.

The degree thesis by Tomoki Kitagawa, Tokyo Institute of Technology, Tokyo, Japan, 2002 (which is not a prior publication) studied rubber-free molding compositions composed of polybutylene terephthalate and of styrene-acrylonitrile copolymers with PMPI as compatibilizer. Other subject areas studied were mixtures of polybutylene terephthalate with PMPI and with terpolymers composed of styrene, acrylonitrile, and maleic anhydride.

It is an object of the present invention to find rubber-containing thermoplastic molding compositions whose mechanical properties have been further improved by compatibilization. In particular, the thermoplastic molding compositions should have improved toughness and in particular improved ultimate tensile strength, together with optimized flowability.

We have found that this object is achieved by means of the thermoplastic molding compositions mentioned at the outset.

Component A

As component A, the molding compositions of the invention comprise at least one rubber-free copolymer in which neither hydroxyl groups, nor acid groups, nor amino groups, nor anhydride groups are present. However, the molding compositions of the invention may also comprise a mixture of two or more, for example from three to five, of these copolymers of different monomeric or structural constitution. Component A is preferably composed of a copolymer of a single type.

These copolymers are based on at least one vinylaromatic monomer, e.g. on a mixture of two or more, for example from three to five different vinylaromatic monomers (a1). Examples of vinylaromatic monomers a1) used are styrene and substituted styrenes, such as C₁-C₈-alkyl-ring-alkylated styrenes, for example p-methylstyrene or tert-butylstyrene. Among these, particular preference is given to styrene, a-methylstyrene, or a mixture of these.

Comonomers (a2) which may be used are at least one ethylenically unsaturated monomer, for example a mixture of two or more, e.g. from three to five different ethylenically unsaturated monomers a2). Preference is given to the use of only one copolymer a2) of a single type. Examples of these comonomers a2) are N-substituted maleiimides, such as N-methyl-, N-phenyl-, or N-cyclohexylmaleiimide, alkyl acrylates, or alkyl alkylacrylates, in particular C₁-C₄-alkyl acrylate or C₁-C₄-alkyl methacrylate, e.g. methyl methacrylate, acrylonitrile, or methacrylonitrile.

In one embodiment here preference is given to copolymers A which are composed of from 60 to 99% by weight, preferably of from 65 to 95% by weight, of at least one vinylaromatic monomer and from 1 to 40% by weight, preferably from 5 to 35% by weight, based on components a1) and a2), which give a total of 100% by weight, of at least one ethylenically unsaturated monomer.

The copolymers A may be linear or branched, or be blocked copolymers or random copolymers. The copolymers A may have low molecular weights, or be of high molecular weight. The copolymers A may have broad or narrow molecular weight distribution.

Component A is particularly preferably a styrene-acrylonitrile copolymer or an α-methylstyrene-acrylonitrile copolymer. Their molar masses (weight-average) are generally in the range from 40 000 to 2 000 000 g/mol, preferably from 60 000 to 150 000 g/mol. Their polydispersity index (PDI=weight-average molecular weight/number-average molecular weight) is preferably smaller than 2.5, with preference smaller than 2.3 (determined by gel permeation chromatography (GPC) against a polystyrene standard and using tetrahydrofuran as eluent, see also M. Lechner et al. Makromolekulare Chemie, 2nd Edn., Birkhäuser Verlag, Basle 1996, pp. 295-299).

The copolymers A are known per se, or may be prepared by processes known per se, such as bulk polymerization, solution polymerization, suspension polymerization, precipitation polymerization, or emulsion polymerization, or else by controlled free-radical polymerization.

The proportion of component A in the molding compositions of the invention is generally from 1 to 50% by weight, preferably from 3 to 45% by weight, In particular from 5 to 40% by weight, based on the total weight of components A to E, which gives 100% by weight in total.

Component B

According to the invention, the thermoplastic molding compositions comprise at least one rubber-free polymer in which at least one, e.g. two or more, for example from three to five, hydroxyl group(s), acid group(s), or amino group(s) is/are present. These polymers B may also contain a mixture of the groups mentioned, e.g. one hydroxyl group and one acid group, or one hydroxyl group and one amino group. The polymers B particularly preferably contain two of these groups. In particular, these are the end groups of the polymer B. Component B may also be a mixture of two or more, e.g. from three to five, different polymers B. Among these, preference is given to the use either of only one polymer B or of a mixture of two polymers B of different type.

Examples of suitable polymers B are condensation polymers, such as polyesters or polyamides.

A first group of polyesters preferred as polymers B are polyalkylene terephthalate having from 2 to 10 carbon atoms in the alcohol moiety.

Polyalkylene terephthalates of this type are known per se and are described in the literature or are obtainable by methods known per se. Their main chain contains an aromatic ring which derives from the aromatic dicarboxylic acid. There may also be substitution in the aromatic ring, e.g. by halogen, such as chlorine or bromine, or by C₁-C₄-alkyl, such as methyl, ethyl, iso- or n-propyl, or n-, iso- or tert-butyl.

These polyalkylene terephthalates may be prepared by reacting aromatic dicarboxylic acids, or their esters or other ester-forming derivatives, with aliphatic dihydroxy compounds in a manner known per se.

Preferred dicarboxylic acids are 2,6naphthalenedicarboxylic acid, terephthalic acid and isophthalic acid, and mixtures of these. Up to 30 mol %,preferably not more than 10 mol %,of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters are polyalkylene terephthalates derived from alkanediols having from 2 to 6 carbon atoms. Among these, particular preference is given to polyethylene terephthalate (PEr), polypropylene terephthalate and polybutylene terephthalate (PBT), and mixtures of these. Preference is also given to PET and/or PBT which comprise as other monomer units, up to 1% by weight, preferably up to 0.75% by weight, of 1,6-hexanediol and/or 2-methyi1,5-pentanediol.

The viscosity number of the polyesters is generally in the range from 50 to 220, preferably from 80 to 160 (measured in 0.5% strength by weight solution in a phenol/o-dichlorobenzene mixture (in a weight ratio of 1:1) at 25° C. in accordance with ISO 1628.

Particular preference is given to polyesters whose carboxyl end group content is up to 100 mval/kg of polyester, preferably up to 50 mval/kg of polyester and In particular up to 40 mval/kg of polyester. Polyesters of this type may be prepared, for example, by the process of DE-A 44 01 055. The carboxyl end group content is usually determined by titration methods (e.g. potentiometry).

Particularly preferred molding compositions comprise, as component B, a mixture of PBT and polyesters other than PBT, for example polyethylene terephthalate (PET). The proportion of the polyethylene terephthalate in the mixture is preferably up to 50% by weight, in particular from 10 to 30% by weight, based on 100% by weight of B.

It is also advantageous, where appropriate, to use recycled PET materials (also termed scrap PET) in a mixture with polyalkylene terephthalates, such as PBT.

Recycled materials are generally:
1) those known as post-industrial recycled materials: these are production wastes during polycondensation or during processing, e.g. sprues from injection molding, start-up material from injection molding or extrusion, or edge trims from extruded sheets or films.
2) post-consumer recycled materials: these are plastics items which are collected and treated after utilization by the end consumer. Blow-molded PET bottles for mineral water, soft drinks and juices are easily the predominant items in terms of quantity.

Both types of recycled material may be used either as regrind or in the form of pellets. In the latter case, the crude recycled materials are isolated and purified and then melted and pelletized using an extruder. This usually facilitates handling and free-flowing properties, and metering for further steps in processing.

The recycled materials used may either be pelletized or in the form of regrind. The edge length should not be more than 6 mm and should preferably be less than 5 mm.

Because polyesters undergo hydrolytic cleavage during processing (due to traces of moisture) it is advisable to predry the recycled material. The residual moisture content after drying is preferably from 0.01 to 0.7, in particular from 0.2 to 0.6%.

Another class to be mentioned is that of fully aromatic polyesters deriving from aromatic dicarboxylic acids and aromatic dihydroxy compounds.

Suitable aromatic dicarboxylic acids are the compounds previously described for the polyalkylene terephthalates. The mixtures preferably used are made from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the formula 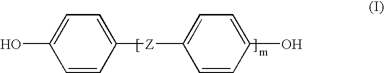
where Z Is alkylene or cycloalkylene having up to 8 carbon atoms, arylene having up to 12 carbon atoms, carbonyl, sulfonyl, oxygen or sulfur or a chemical bond, and where m is from 0 to 2. The phenylene groups in the compounds (I) may also have substitution by C₁-C₆-alkyl or alkoxy and fluorine, chlorine or bromine.

Examples of parent compounds for these compounds are
dihydroxybiphenyl,
di(hydroxyphenyl)alkane,
di(hydroxyphenyl)cycloalkane,
di(hydroxyphenyl) sulfide,
di(hydroxyphenyl) ether,
di(hydroxyphenyl) ketone,
di(hydroxyphenyl) sulfoxide,
α,α′-di(hydroxyphenyl)dialky!benzene,
di(hydroxyphenyl) sulfone, di(hydroxybenzoyl)benzene, resorcinol, and
hydroquinone, and also the ring-alkylated and ring-halogenated derivatives of these.

Among these, preference is given to
4,4′-dihydroxydiphenyl,
2,4-di(4′-hydroxyphenyl)-2-methylbutane
α, α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,

and in particular to
2,2-di(4′-hydroxyphenyl)propane
2,2-di(3′,5-dichlorodihydroxyphenyl)propane,
1,1 -di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane

or mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in US-A 3 651 014. Corresponding products are also available commercially, e.g. Hytrel® (DuPont).

Other suitable components B are polyamides having an aliphatic semicrystalline or semiaromatic, or else amorphous structure of any type, and blends of these, Including poly-etheramides, such as polyether block amides. For the purposes of the present invention, polyamides are all known polyamides and those obtainable by processes known per se.

The viscosity number of these polyamides is generally from 90 to 350 ml/g, preferably from 110 to 240 ml/g, determined on a 0.5% strength by weight solution in 96% strength by weight sulfuric acid at 25° C. to ISO 307.

Preference is given to semicrystalline or amorphous polyamides with molecular weight (weight-average) of at least 5000. Examples of these are polyamides derived from lactams having from 7 to 13 ring members, for example polycaprolactam, polycaprylolactam, and polylaurolactam, and also polyamides obtained by reacting dicarboxylic acids with diamines.

Dicarboxylic acids which may be used are alkanedicarboxylic acids having from 6 to 12 carbon atoms, in particular from 6 to 10 carbon atoms, and aromatic dicarboxylic acids. Acids which may be mentioned here are adipic acid, azelaic acid, sebacic acid, dodecanedioic acid (=decanedicarboxylic acid), and terephthalic and/or isophthalic acid.

Particularly suitable diamines are alkanediamines having from 6 to 12 carbon atoms, in particular from 6 to 8 carbon atoms, and also m-xylylenediamine, di(4-aminophenyl)methane, di(4-aminocyclohexyl)methane, 2,2-di(4-aminophenyl)propane, or 2,2-di(4-aminocyclohexyl) propane.

Preferred polyamides are polyhexamethyleneadipamide (PA 66) and polyhexamethylenesebac-amide (PA 610), polycaprolactam (PA 6), and also nylon-6/6,6 copolyamides, in particular with from 5 to 95% by weight of caprolactam units.

PA 6, PA 66 and nylon-6/6,6 copolyamides are particularly preferred. Nylon-6 (PA6) is very particular preferred.

Mention may also be made of polyamides obtainable, for example, by condensing 1,4-diaminobutane with adipic acid at an elevated temperature (nylon-4,6).

Other examples are polyamides obtainable by copolymerizing two or more of the abovementioned monomers, and mixtures of two or more polyamides in any desired mixing ratio are suitable.

Such semiaromatic copolyamides as PA 6/6T and PA 66/6T have also proven particularly advantageous with triamine content of less than 0.5% by weight, preferably less than 0.3% by weight (see EP-A 299 444). The semiaromatic copolyamides with low triamine content may be prepared by the processes described in EP-A 129 195 and 129 196.

The following list, which is not comprehensive, includes the polyamides mentioned and others for the purposes of the present invention (the monomers being given in brackets):
PA 46 (tetramethylenediamine, adipic acid)
PA 66 (hexamethylenediamine, adipic acid)
PA 69 (hexamethylenediamine, azelaic acid)
PA 610 (hexamethylenediamine, sebacic acid)
PA 612 (hexamethylenediamine, decanedicarboxylic acid)
PA 613 (hexamethylenediamine, undecanedicarboxylic acid)
PA 1212 (1,12-dodecanediamine, decanedicarboxylic acid)
PA 1313 (1,1 3-diaminotridecane, undecanedicarboxylic acid)
PA MXD6 (m-xylylenediamine, adipic acid)
PA TMDT (trimethyihexamethylenediamine, terephthalic acid)
PA 4 (pyrrolidone)
PA 6 (ε-caprolactam)
PA 7 (enantholactam)
PA 8 (caprylolactam)
PA 9 (9-aminopelargonic acid)
PA 11 (11 -aminoundecanoic acid)
PA 12 (laurolactam)

These polyamides and their preparation are known.

Brief details will be given below of the preparation of the preferred polyamides PA 6, PA 66, and nylon-6/6,6 copolyamide.

The starting monomers are preferably polymerized or polycondensed by the usual processes. For example, caprolactam may be polymerized by the continuous processes described in DE-A 14 95 198 and DE-A 25 58 480. The polymerization of AH salt to prepare PA 66 may proceed by the conventional batch process (see: Polymerization Processes pp. 424-467, in particular pp. 444-446, Interscience, New York, 1977), or by a continuous process, e.g. as in EP-A 129 196.

Concomitant use may be made of conventional chain regulators in the polymerization. Examples of suitable chain regulators are triacetonediamine compounds (see WO-A 95/28443), monocarboxylic acids, such as acetic acid, propionic acid, and benzoic acid, and also bases, such as hexamethylenediamine, benzylamine, and 1,4-cyclohexanediamine. Other suitable chain regulators are C₄-C₁₀ dicarboxylic acids, such as adipic acid, azelaic acid, sebacic acid, dodecanedioic acid; C₅-C₈ cycloalkanedicarboxylic acids, such as cyclohexane-1,4-dicarboxylic acid; benzene- and naphthalenedicarboxylic acids, such as isophthallc acid, terephthalic acid, and naphthalene-2,6-dicarboxylic acid.

The resultant polymer melt is discharged from the reactor, cooled, and pelletized. The resultant pellets are subjected to post-polymerization. This takes place in a manner known per se by heating the pellets to a temperature T below the melting point Tₘ or crystallite melting point T_{c} of the polyamide. The post-polymerization sets the final molecular weight of the polyamide (measurable as viscosity number VN, see VN data above). The post-polymerization usually takes from 2 to 24 hours, in particular from 12 to 24 hours. Once the desired molecular weight has been achieved the pellets are cooled in the usual way.

Appropriate polyamides are obtainable from BASF with the trade name Ultramid®.

The proportion of component B generally present in the molding compositions of the invention is from 1 to 95.5% by weight, preferably from 3 to 91.2% by weight, in particular from 5 to 86.8% by weight, based on the total weight of components A to E, which give 100% by weight in total.

Component C

As component C), the molding compositions of the invention comprise from 3 to 50% by weight, preferably from 5 to 30% by weight, and particularly preferably from 7 to 25% by weight, of at least one rubber. An example of component C is a mixture of two or more, e.g. from three to five, rubbers of different type. According to the invention, a rubber is an elastomeric polymer whose glass transition temperature Tg is 0° C. or below (Tg determined by Differential Scanning Calorimetry (DSC) to DIN 53765).

Suitable rubbers C are in principle any of the elastomeric polymers whose Tg is ≦0° C., in particular those which comprise, as rubber,
a diene rubber based on dienes such as butadiene or isoprene or a mixture of said dienes,
an alkyl acrylate rubber based on alkyl esters of acrylic acid, e.g. n-butyl acrylate and 2-ethylexyl acrylate or a mixture of said alkyl esters,
an EPDM rubber based on ethylene, propylene, and a diene,
a silicone rubber based on a polyorganosiloxane, or comprise a mixture of these rubbers.

The rubber C is preferably a graft polymer composed of a graft base and of a graft.

Preferred graft polymers C contain, based on C,
c1) from 30 to 95% by weight, preferably from 40 to 90% by weight, and particularly preferably from 40 to 85% by weight, of an elastomeric graft base composed of, based on c1),
c11) from 50 to 100% by weight, preferably from 60 to 100% by weight, and particularly preferably from 70 to 100% by weight, of a C₁-C₁₀-alkyl ester of acrylic acid,
c12) from 0 to 10% by weight, preferably from 0 to 5% by weight, and particularly preferably from 0 to 2% by weight, of a polyfunctional, crosslinking monomer,
c13) from 0 to 40% by weight, preferably from 0 to 35% by weight, and particularly preferably from 0 to 28% by weight, of one or more other monoethylenically unsaturated monomers,

or of
c11*) from 50 to 100% by weight, preferably from 60 to 100% by weight, and particularly preferably from 65 to 100% by weight, of a diene having conjugated double bonds,
c12*) from 0 to 50% by weight, preferably from 0 to 40% by weight, and particularly preferably from 0 to 35% by weight, of one or more monoethylenically unsaturated monomers,

or of
c11**) from 50 to 100% by weight, preferably from 60 to 100% by weight, and particularly preferably from 65 to 100% by weight, of a mixture of ethylene, propylene, and a diene,
c12**) from 0 to 50% by weight, preferably from 0 to 40% by weight, and particularly preferably from 0 to 35% by weight, of one or more other monoethylenically unsaturated monomers, and

c2) from 5 to 70% by weight, preferably from 10 to 60% by weight, and particularly preferably from 15 to 60% by weight, of a graft composed of, based on a2),
c21) from 50 to 100% by weight, preferably from 60 to 100% by weight, and particularly preferably from 65 to 100% by weight, of a styrene compound, c22) from 0 to 40% by weight, preferably from 0 to 38% by weight, and particularly preferably from 0 to 35% by weight, of acrylonitrile or methacrylontrile, or a mixture of these, and
c23) from 0 to 40% by weight, preferably from 0 to 30% by weight, and particularly preferably from 0 to 20% by weight, of one or more other monoethylenically unsaturated monomers.

Particularly suitable C₁-C₁₀-alkyl acrylates, component cl1), are ethyl acrylate, 2-ethylhexyl acrylate, and n-butyl acrylate. Preference is given to 2-ethylhexyl acrylate and n-butyl acrylate, and very particular preference is given to n-butyl acrylate. It is also possible to use mixtures of various alkyl acrylates which differ in their alkyl radical.

Crosslinking monomers c12) are bi- or polyfunctional comonomers having at least two olefinic double bonds, e.g. butadiene and isoprene, divinyl esters of dicarboxylic acids, e.g. of succinic acid or of adipic acid, diallyl or divinyl ethers of dihydric alcohols, e.g. of ethylene glycol or of 1,4-butanediol, diesters of acrylic or methacrylic acid with the dihydric alcohols mentioned, 1,4-divinylbenzene, and triallyl cyanurate. Particular preference is given to the acrylic ester of tricyclodecenyl alcohol (see DE-A 12 60 135), known as dihydrodicyclopentadienyl acrylate, and also to the allyl esters of acryclic acid and of methacrylic acid.

Crosslinking monomers c12) may be present or absent in component C, depending on the nature of the component C to be prepared, and in particular depending on the desired properties of component C.

If crosslinking monomers c12) are present in component C, the amounts are from 0.01 to 10% by weight, preferably from 0.3 to 8% by weight, and particularly preferably from 1 to 5% by weight, based on c1).

Examples of the other monoethylenically unsaturated monomers c13) which may be present in the graft base c1) with concomitant reduction in the amounts of the monomers c11) and c12) are:

vinylaromatic monomers, such as styrene and styrene derivatives, e.g. as given under A;

acrylonitrile, methacrylonitrile;

C₁-C₄-alkyl esters of methacrylic acid, e.g. methyl methacrylate, and also the glycidyl esters, glycidyl acrylate and glycidyl methacrylate;

N-substituted maleimides, such as N-methyl, N-phenyl-, and N-cyclohexylmaleimide; acrylic acid, methacrylic acid, and also dicarboxylic acids, such as maleic acid, fumaric acid and itaconic acid, and also anhydrides of these, such as maleic anhydride;

Nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide, and methacrylamide;

aromatic and araliphatic esters of acrylic acid or methacrylic acid, e.g. phenyl acrylate, phenyl methacrylate, benzyl acrylate, benzyl methacrylate, 2-phenylethyl acrylate, 2-phenylethyl methacrylate, 2-phenoxyethyl acrylate, and 2-phenoxyethyl methacrylate;

unsaturated ethers, such as vinyl methyl ether,

and also mixtures of these monomers.

Preferred monomers c13) are styrene, acrylonitrile, methyl methacrylate, glycidyl acrylate, and glycidyl methacrylate, acrylamide, and methacrylamide.

The graft base c1) may also be composed of the monomers c11*) and c12*), instead of the graft base monomers c11) to c13).

Dienes having conjugated double bonds, c11*), which may be used are butadiene, isoprene, norbomene, and halogen-substituted derivatives of these, such as chloroprene. Preference is given to butadiene and isoprene, in particular butadiene.

Monoethylenically unsaturated monomers c12*) which may be used concomitantly are the monomers mentioned above for the monomers c13).

Preferred monomers c12*) are styrene, acrylonitrile, methyl methacrylate, glycidyl acrylate and glycidyl methacrylate, acrylamide, and methacrylamide.

The graft core c1) may also be composed of a mixture of the monomers c11) to c13), and c11*) to c12*).

The graft base c1) may also be composed of the monomers c11**) and c12**), instead of the graft base monomers c11) to c13) or c11*) and c12*). Ethylidenenorbornene and dicyclopentadiene are particularly suitable dienes used in a mixture with ethylene and propylene in the monomer mixture c11**).

Other monoethylenically unsaturated monomers c12**) which may be used concomitantly are the monomers mentioned for c13).

The graft base may also be composed of a mixture of the monomers c11) to c13) and c11 **) to c12**), or of a mixture of the monomers c11 *) to c12*) and c11**) to c12**), or of a mixture of the monomers c11) to c13), c11 *) to c12*), and C11**) to c12**).

In relation to the monomers c21) and c23), reference should be made to the descriptions given at an earlier stage above for components a1) and, respectively, a3). The graft c2) may therefore contain other monomers c22), or c23), or a mixture of these, with concomitant reduction in the amount of the monomers c21). The graft c2) is preferably composed of polymers of styrene, of styrene and acrylonitrile, of a-methylstyrene and acrylonitrile, or of styrene and methyl methacrylate.

The graft c2) may be prepared under conditions identical with those used to prepare the graft base c1), and the graft c2) may be prepared in one or more steps of a process. In this process, the monomers c21), c22), and c23) may be added individually or in a mixture with one another. The monomer ratio of the mixture may be constant over time or be represented by a gradient. Combinations of these procedures are also possible.

For example, styrene alone, and then a mixture of styrene and acrylonitrile, may be polymerized onto the graft base c1).

The overall constitution is independent of the embodiments mentioned of the process.

Other suitable graft polymers have two or more “soft” and “hard” stages, for example having the structure c1) -c2) -c1) -c2) or c2) -c1) -c2), especially if the particles are relatively large.

If the grafting gives rise to ungrafted polymers composed of the monomers c2), these amounts, which are generally below 10% by weight of c2), are counted with the weight of component A.

There are various ways of preparing the graft polymers C, in particular in emulsion, in microemulsion, in miniemulsion, in suspension, in microsuspension, in minisuspension, in a precipitation polymerization, in bulk, or in solution, continuously or batchwise. These processes are known to the person skilled in the art and are described by way of example in PCT/EP/01/091 14.

The process for preparing the graft polymers may also be a combined process in which at least two polymerization processes are combined with one another. Mention should be made in particular here of bulk/solution, solution/precipitation, bulk/suspension and bulk/emulsion, the first-named being the starting process and the second-named being the final process.

In all of the processes mentioned, such as emulsion polymerization, miniemulsion polymerization, or microsuspension polymerization, substantial control of the size of the rubber particles is possible via appropriate selection and control of the conditions during preparation of the dispersion (e.g. selection of homogenizer, duration of homogenization, quantitative proportions of monomers:water:emulsifier, dispersing procedure (single, multiple, batch or continuous, recirculation), rotation rate of homogenizer, etc.).

The selection of the precise polymerization conditions, in particular the nature, amount, and feed method for the emulsifier, and for the other polymerization auxiliaries, is preferably such that the resultant rubber particles obtained by emulsion polymerization have an average size (ponderal median particle size, d₅₀ ) which is usually from 50 to 500 nm, preferably from 70 to 300 nm and particularly preferably from 80 to 140 nm. The particles obtained during miniemulsion polymerization generally likewise have sizes from 50 to 500 nm (ponderal median particle size, d₅₀ ). Microemulsion polymerization generally gives particle sizes (ponderal median particle sizes, d₅₀ ) in the range from 20 to 80 nm. Each of the particle sizes given is the d₅₀ (ponderal median, determined by means of analytical uftracentrifuge measurement as described by W. Mächtle, S. Harding (Eds.), AUC in Biochemistry and Polymer Science, Cambridge, UK 1991). The microsuspension polymerization process generally gives particles of a size (ponderal median particle size, d₅₀) in the range from 0.3 to 10 μm (from 300 to 10 000 nm). The particle sizes may be determined by the Fraunhofer diffraction method (H. G. Barth, Modern Methods of Particle Size Analysis, Wiley, NY 1984).

In one preferred embodiment, the polymerization is carried out by means of the emulsion procedure, the rubber particles initially obtained in a first stage and present in dispersion in the aqueous phase being agglomerated in a second stage. It is preferable for there to be only particles of one type present in the dispersion, i.e. those based on a graft base c. However, there may also be more than one type, for example two or more different types, of particles present in the dispersion. One way in which this can be achieved is the mixing of different dispersions of particles, for example dispersions prepared separately from one another.

Processes for agglomerating rubber particles are known to the person skilled in the art. For example, use may be made of physical processes, such as freeze agglomeration or pressure agglomeration. However, use may also be made of chemical methods for agglomerating rubber particles. The latter include the addition of inorganic or organic acids. An agglomeration polymer is preferably used for the agglomeration process. Polyethylene oxide polymers or polyvinyl alcohols may be mentioned as examples of these. Particular preference is given to the use of agglomeration polymers in which there are substantially no free acid groups present. Copolymers of C₁-C₁₂-alkyl acrylates or C₁-C₁₂-alkyl methacrylates with polar comonomers, such as acrylamide, methacrylamide, ethacrylamide, n-butylacrylamide, or maleiimide, are some of the suitable agglomeration polymers.

In one agglomeration method, only a portion of the rubber particles is agglomerated, the result being a bimodal distribution. In one first embodiment here, more than 50%, preferably from 75 to 95%, of the particles (number distribution) are generally in unagglomerated condition after the agglomeration process. In a second embodiment, the method of carrying out the agglomeration is such that, after the agglomeration process, the rubber particles have a polymodal particle size distribution in which less than 40% by weight, preferably less than 37.5% by weight, more preferably less than 35% by weight, particularly preferably less than 32.5% by weight, in particular less than 30% by weight, of the particles lie in each particle-size range of width 50 nm. Unless otherwise stated, the median particle diameter here is based on weight In particular, it is the d₅₀ of the cumulative weight distribution (see above).

Following the agglomerization step, the graft (c2) may be formed by graft-polymerizing the appropriate monomers.

These agglomeration processes are described by way of example in EP/PCT/01 /08114.

Component D

According to the invention, the component D used comprises at least one terpolymer, e.g. a mixture of two or more, for example from three to five, terpolymers of different structure, e.g. branched or linear, or of different monomeric constitution, e.g. random or block. Among these, preference is given to the use of one terpolymer of a single type as component D. Terpolymers which are substantially linear and substantially random are among the preferred terpolymers. The monomeric unit d1) used comprises a vinylaromatic monomer or a mixture of two or more, e.g., from three to five, different vinylaromatic monomers. Examples of vinylaromatic monomers which may be used are styrene and substituted styrenes, e.g. C₁-C₈-alkyl-ring-alkylated styrenes, such as p-methylstyrene or t-butylstyrene. Among these, particular preference is given to the use of styrene and α-methylstyrene or a mixture of these. In particular, styrene alone is used as d1).

The monomeric unit d2) from which the terpolymer D is obtainable may be a C₁-C₄-alkyl (meth)acrylate, or a mixture of two or more, e.g. from three to five, different C₁-C₄-alkyl (meth)acrylates, preference among these being given to the use of methyl methacrylate. However, methacrylonitrile or acrylonitrile may also be used as d2). A mixture of one or more C₁-c₄-alkyl (meth)acrylates and methacrylonitrile and/or acrylonitrile may moreover be used as d2). Acrylonitrile alone is particularly preferably used as d2).

According to the invention, the monomeric unit d3) used to prepare the terpolymers D comprises at least one monomer which contains an α,β-unsaturated anhydride, or, for example, comprises a mixture of two or more, e.g. from three to five, of these monomers. Aromatic or aliphatic compounds having at least one anhydride group may be used here. Preference is given to monomers which have not more than one anhydride group. Maleic anhydride is particularly preferably used as d3).

According to the invention, the proportion of component d3) in the terpolymer is from 0.2 to 4% by weight, particularly preferably from 0.3 to 3.5% by weight, in particular from 0.3 to 3% by weight, based on the total weight of components d1) to d3), which give 100% by weight in total. The proportion of the two other components, d1) and d2), may vary within wide ranges, and mainly depends on the required miscibility of component D with components A to C. The proportion of component d1) is generally from 60 to 94.8% by weight, preferably from 61.5 to 89.7% by weight, in particular from 68 to 84.7% by weight, based on the total weight of components d1) to d3), which give 100% by weight in total. Correspondingly, the amount of component d2) present in the terpolymers is from 5 to 36% by weight, preferably from 10 to 35% by weight, in particular from 15 to 29% by weight.

The molar mass of the terpolymer may vary within wide limits. Average molar masses in the range from 60 000 to 350 000 g/mol have proven suitable. Molar masses in the range from 80 000 to 300 000 g/mol are often advantageous. Particularly preferred terpolymers have molar masses in the range from 90 000 to 210 000 g/mol. The molar masses given above are weight averages, determined by GPC, as described above.

Various processes may be used to prepare the terpolymers D, depending on the desired structural constitution. The terpolymers are preferably prepared by free-radical polymerization, particularly preferably by continuous solution polymerization. An example of a method for this dissolves the monomers in methyl ethyl ketone, and either initiates the polymerization thermally or, if desired or necessary, adds an initiator, such as a peroxide, to this solution. The reaction mixture is generally polymerized for two or more hours at an elevated temperature, and then worked up.

The proportion of component D in the molding compositions of the invention is generally adapted to the requirements placed on the product. The molding compositions of the invention preferably comprise from 0.4 to 30% by weight, particularly preferably from 0.5 to 20% by weight, in particular from 1 to 15% by weight, of the terpolymer D, based on the total weight of components A to E.

Component E

As component E, the molding compositions of the invention comprise at least one compound, or a mixture or two or more, e.g. from three to five, different compounds, having two or more, for example from three to five, isocyanate groups.

Compounds which may be used as component E are organic polyisocyanates, e.g. the aliphatic, cycloaliphatic, araliphatic, or aromatic polyfunctional isocyanates know per se.

Individual compounds which should be mentioned by way of example are: alkylene diisocyanates having from 4 to 12 carbon atoms in the alkylene radical, e.g. hexamethylene 1,6-diisocyanate; cycloaliphatic diisocyanates, e.g. cyclohexane 1,3- or 1,4-diisocyanate, and also any desired mixture of these isomers, hexahydrotolylene 2,4- or 2,6-diisocyanate, and also the corresponding isomer mixtures, dicyclohexylmethane 4,4′-, 2,2′-, or 2,4′-diisocyanate, and also the corresponding isomer mixtures, araliphatic diisocyanates, such as xylylene 1,4-diisocyanate or xylylene diisocyanate isomer mixtures, but preferably aromatic di- and polyisocyanates, such as tolylene 2,4- or 2,6-diisocyanate (TDI) and the corresponding isomer mixtures, diphenylmethane 4,4′-, 2,4′-, or 2,2′-diisocyanate (MDI) and the corresponding isomer mixtures, mixtures of diphenylmethane 4,4′- and 2,4′-diisocyanates, polyphenyl polymethylene polyisocyanates, mixtures of diphenylmethane 4,4′-, 2,4′-, and 2,2′-diisocyanates and polyphenyl polymethylene polyisocyanates (crude MDI), and mixtures of crude MDI and tolylene diisocyanates. The organic di- and polyisocyanates may be used individually or in the form of mixtures.

Use is often made of what are known as modified polyfunctional isocyanates, i.e. products obtained via chemical reaction of organic di- and/or polyisocyanates. By way of example, mention may be made of di- and/or polyisocyanates containing isocyanurate groups and/or containing urethane groups. Examples of individual compounds which may be used are organic, preferably aromatic polyisocyanates containing urethane groups and having NCO contents of from 15 to 33% by weight, preferably from 21 to 31% by weight, based on the total weight of the polyisocyanate. Other suitable compounds are prepolymers containing isocyanate groups and having NCO contents of from 3.5 to 25% by weight, preferably from 14 to 21% by weight, based on the total weight of the polyisocyanate, prepared by polyester polyols and/or preferably from polyether polyols, and diphenylmethane 4,4′-diisocyanate, a mixture of diphenylmethane 2,4′- and 4,4′-diisocyanate, tolylene 2,4- and/or 2,6-diisocyanates, or crude MDI. Other compounds which have proven successful are liquid polyisocyanates containing isocyanurate rings and having NCO contents of from 33 to 15% by weight, preferably from 21 to 31% by weight, based on the total weight of the polyisocyanate, e.g. based on diphenylmethane 4,4′-, 2,4′-, and/or 2,2′-diisocyanate, isophorone diisocyanate, or hexamethylene diisocyanate, and/or tolylene 2,4-and/or 2,6-diisocyanate.

The modified polyisocyanates may, where appropriate, be mixed with one another or with unmodified organic polyisocyanates, e.g. diphenylmethane 2,4′- or 4,4′-diisocyanate, crude MDI, or tolylene 2,4- and/or 2,6-diisocyanate.

Compounds which have proven particularly successful are polymers containing isocyanurate groups and based on hexamethylene diisocyanate, and also crude MDI.

The amount of component E which may be present in the thermoplastic molding compositions of the invention may vary, and substantially depends on the requirements placed upon the product. The proportion present of component E is preferably from 0.1 to 5% by weight, particularly preferably from 0.2 to 3% by weight, in particular from 0.2 to 1% by weight, based on the total weight of components A to E.

Besides components A to E, the molding compositions of the invention may optionally comprise other components. In this connection, mention should be made of fillers and reinforcing materials (component F) and additives (component G). The molding compositions of the invention also generally comprise small amounts of water. These mostly do not exceed 0.5% by weight, based on the weight of components A to E.

Component F

The amount of component F generally present in the molding compositions of the invention is from 0 to 60% by weight, based on the total weight of components A to E. For example, in one of the preferred embodiments the proportion of component F may be from 3 to 55% by weight, based on the total weight of components A to E.

Fibrous or particulate fillers are preferably carbon fibers, or in particular glass fibers. The glass fibers used may be composed of E glass, of A glass, or of C glass, and have preferably been provided with a size and with a coupling agent. The diameter is generally from 6 to 20 μm. Use may be made either of continuous-filament fibers (rovings) or else of chopped glass fibers with a length of from 1 to 10 mm, preferably from 3 to 6 mm. It is also possible to add fillers or reinforcing materials such as glass beads, mineral fibers, whiskers, aluminum oxide fibers, mica, kaolin, talc, powdered quartz, and wollastonite. Use may also be made of metal flakes (such as metal flakes from Transmed Corp.), metal powders, metal fibers, metal-coated fillers (such as nickel-coated glass fibers), and also other added materials which provide screening from electromagnetic waves. Use may in particular be made of Al flakes (K 102 from Transmed) for EMI (Electromagnetic Interference) applications. The molding compositions may moreover be blended with additional carbon fibers, conductivity black, or nickel-coated carbon fibers. Gachter/Muller, Kunststoff-Additive, 3rd Edition, Hanser-Verlag, 1990 pages 549-578 and 617-662 gives a general description of suitable fibrous or particulate fillers.

Component G

The amount of component G generally present in the thermoplastic molding compositions of the invention is from 0 to 20% by weight, based on the total weight of components A to E. For example, In one of the preferred embodiments the proportion of component G is from 0.1 to 15% by weight, based on the total weight of components A to E.

Examples of this component G are processing aids and stabilizers, such as UV stabilizers, lubricants, phosphorus stabilizers, and antistatic agents. Other ingredients are dyes, pigments, or antioxidants. Stabilizers can serve to improve heat resistance, increase resistance to light, increase hydrolysis resistance, and increase chemical resistance. Lubricants are in particular advantageous during the production of moldings.

Suitable stabilizers are the usual hindered phenols, but also vitamin E, or compounds of similar structure. HALS stabilizers are suitable, as are benzophenones, resorcinols, salicylates, benzotriazoles, and other compounds. (Examples being IRGANOX®, TINUVIN®, e.g. TINUVIN® 770 HALS absorber, bis-2,2,6,6-tetramethyl-4-piperidyl) sebacate, and TINUVIN® P (UV absorber, (2H-benzotriazol-2-yl)-4-methylphenol), TOPANOL®). Suitable lubricants and mold-release agents are stearic acids and stearyl alcohol, stearic esters, and higher fatty acids in general, derivatives of these, and appropriate fatty acid mixtures having from 12 to 30 carbon atoms.

Other additives which may be used are silicone oils, oligomeric isobutylene, and similar substances. It is also possible to use pigments, dyes, color brighteners, such as ultramarine blue, phthalocyanines, titanium dioxide, cadmium sulfides, derivatives of perylenetetracarboxylic acid.

Other components G which may be used are transesterification stabilizers, such as Irgaphos® P-EPQ, tetrakis(2,4-di-tert-butylphenyl) 4,4′-diphenylenediphosphonite from Ciba-Geigy, or phosphates, such as monozinc phosphate. Preferred antioxidants are phenolic antioxidants. Preferred UV stabilizers are triazoles.

Preparation of molding compositions

The molding compositions of the invention are prepared by mixing components A to E and, where appropriate, F and G. The sequence in which the components are mixed is as desired.

The molding compositions of the invention may be prepared by processes known per se, such as extrusion. One way of preparing the molding compositions of the invention mixes the starting components in conventional mixing apparatus, such as screw extruders, preferably twin-screw extruders, Brabender mixers, or Banbury mixers, or else in kneaders, and then extrudes them. The extrudate is cooled and comminuted. The sequence of mixing of the components may be varied. For example, two or, where appropriate, three components may be premixed, or else all of the components may be mixed together. Relatively Intimate mixing is advantageous to maximize the homogeneity of mixing. Average mixing times required here are generally from 0.2 to 30 minutes at temperatures of from 230 to 300° C., preferably from 230 to 280° C. The extrudate is generally cooled and comminuted.

The molding compositions of the invention have a good balance of impact strength and flowability, and in particular markedly increased ultimate tensile strength. The molding compositions of the invention which, as component B, comprise a polyester, in particular polybutylene terephthalate, moreover have good dimensional stability, even when exposed to changes in temperature and humidity. The molding compositions of the invention whose component C is a diene-based rubber generally have particular toughness advantages, while molding compositions whose rubber component is based on an acrylate have good suitability for the production of materials for outdoor use.

The properties mentioned make the molding compositions suitable for producing moldings, and these may be used in the household, electrical, motor vehicle, or medical technology sector, for example. For producing fixed moldings which are intended to have no expansion gaps, examples being protective covers, ventilation grilles, radio covers for motor vehicle interiors, particular preference is given to molding compositions of the invention which comprise polybutylene terephthalate as component B and, as component C, a graft rubber with an acrylate graft base.

The thermoplastic molding compositions of the invention may be processed by the known methods of thermoplastics processing, e.g. by extrusion, injection molding, calendering, blow molding, compression molding, or sintering.

The Invention is further illustrated below by way of examples.

### EXAMPLES

Component A1:

Copolymer based on styrene/acrylonitrile (ratio by weight: 75/25), viscosity number 80 ml/g.

Component B1:

Polybutylene terephthalate, e.g. Ultradur®B 4500 from BASF Aktiengesellschaft, characterized by a viscosity number of 130 ml/g (measured on a 0.5% strength by weight o-dichlorobenzen/phenol solution).

Component C1:

Graft rubber having 60% by weight of a graft base composed of poly-n-butyl acrylate and 40% by weight of a graft based on a mixture of styrene and acrylonitrile.

Component C2:

Graft rubber having 62% by weight of a graft composed of styrene and acrylonitrile and having 38% by weight of a graft base composed of polybutadiene, e.g. Ronfalin® TZ 237.

Component D1:

Terpolymer based on styrene/acrylonitrile/maleic anhydride (ratio by weight: 75/24.510.5), viscosity number 80 ml/g.

Component D2:

Terpolymer based on styrene/acrylonitrile/maleic anhydride (ratio by weight: 75/24.1/0.9),

viscosity number 80 ml/g.

Component D3:

Terpolymer based on styrene/acrylonitrile/maleic anhydride (ratio by weight: 68/29.9/2.1), viscosity number 65 ml/g.

Component D4:

Terpolymer based on styrene/acrylonitrile/maleic anhydride (ratio by weight: 73/22.3/4.7), viscosity number 69 ml/g.

Component E1:

Poly(methylene(phenylene isocyanate)), having an NCO content of 31.2% by weight (determined to DIN 53185) and having a viscosity of 200 mPas at 25° C. (determined to DIN EN ISO 3219), e.g. Lupranat® M20A from BASF Aktiengesellschaft.

Component E2:

Polyisocyanate containing isocyanurate groups and based on hexamethylenediamine, having an NCO content of 21.0% by weight, determined to DIN 53185 and having a viscosity of 3000 mPa s at 23° C./2500 s⁻¹[determined according to DIN EN ISO 3219], e.g. Basonat® HI 100 from BASF Aktiengesellschaft.

Component F1:

Glass fiber, provided with an epoxy size and having a fiber diameter of 10μm and a staple length of 4.5 mm.

Preparation and testing of molding compositions:

A twin-screw extruder was used to mix the components. The melt was passed through a water bath and pelletized. The mechanical properties were then determined on specimens produced by injection molding (melt temperature: 250° C./mold temp. 60° C.).

Heat resistance was determined to Vicat B. Impact resistance of the products was determined on ISO specimens to ISO 179 1eA.

Modulus of elasticity and tensile strain at break were determined to ISO 527.

The constitutions of the molding compositions and the results of the tests are listed in Tables 1 and 2.

TABLE 1

| Component | | Molding composition No. | | | | | | | | |
|---|---|---|---|---|---|---|---|---|---|---|
| [% by weight] | | 1c | 2c | 3c | 1 | 4c | 5c | 6c | 7c | 2 |
| A1 | | 5 | — | 5 | — | — | — | 3 | — | — |
| B | | 55 | 55 | 54.5 | 54.5 | 54.5 | 54.5 | 39 | 39 | 38.5 |
| C1 | | 40 | 40 | 40 | 40 | 40 | 40 | 28 | 28 | 28 |
| D3 | | — | 5 | — | 5 | — | 5 | — | 3 | 3 |
| D4 | | — | — | — | — | 5 | — | — | — | — |
| E1 | | — | — | 0.5 | 0.5 | 0.5 | — | — | — | 0.5 |
| E2 | | — | — | — | — | — | 0.5 | — | — | |
| F | | — | — | — | — | — | — | 30 | 30 | 30 |
| Vicat B | [° C.] | 104 | 104 | 104 | 104 | 104 | 105 | 155 | 153 | 156 |
| ak | [kJ/m²] | 6.0 | 5.9 | 5.8 | 9.1 | 6.1 | 11.4 | 6.1 | 5.7 | 6.9 |
| Modulus of | [N/mm²] | 2260 | 2250 | 2269 | 2250 | 2260 | 2260 | 9700 | 9600 | 9670 |
| elasticity | | | | | | | | | | |
| Tensile strain | [%] | 7 | 8 | 8 | 25 | 6 | 31 | 2.2 | 1.9 | 3.1 |
| at break | | | | | | | | | | |

c: Comparative experiments

c: Comparative experiments

TABLE 2

| Component | | Molding composition No. | | | | | | | |
|---|---|---|---|---|---|---|---|---|---|
| [% by weight] | | 8c | 9c | 10c | 3 | 4 | 11c | 5 | 6 |
| A1 | | 5 | — | 5 | — | — | — | — | — |
| B | | 55 | 55 | 54.5 | 54.5 | 54.5 | 54.5 | 54.5 | 54.5 |
| C2 | | 40 | 40 | 40 | 40 | 40 | 40 | 40 | 40 |
| D1 | | — | — | — | — | — | — | — | 5 |
| D2 | | — | 5 | — | 5 | — | — | — | — |
| D3 | | — | — | — | — | 5 | — | 5 | — |
| D4 | | — | — | — | — | — | 5 | — | — |
| E1 | | — | — | 0.5 | 0.5 | 0.5 | 0.5 | — | — |
| E2 | | — | — | — | — | — | — | 0.5 | 0.5 |
| Vicat B | [° C.] | 103 | 104 | 104 | 104 | 104 | 104 | 103 | 104 |
| ak | [kJ/m²] | 7.8 | 6.5 | 5.8 | 16.1 | 15.4 | 8.5 | 17.5 | 15.9 |
| Modulus of | [N/mm²] | 2200 | 2220 | 2200 | 2210 | 2230 | 2200 | 2190 | 2200 |
| elasticity | | | | | | | | | |
| Tensile strain | [%] | 9 | 8 | 8 | 54 | 47 | 11 | 61 | 53 |
| at break | | | | | | | | | |

c: Comparative experiments

c: Comparative experiments

The experiments confirm the excellent property profile of the thermoplastic molding compositions of the invention, and particular emphasis should be given to the improved tensile strain at break and notched impact strength.

1. A thermoplastic molding composition, comprising
A) at least one rubber-free copolymer in which no hydroxyl group, acid group, amino group, or anhydride group is present, based on at least one vinylaromatic monomer (a1) and at least one copolymer (a2),
B) at least one rubber-free polymer in which at least one hydroxyl group, acid group, or amino group is present,
C) from 3 to 50% by weight, based on the total weight of components A to E, of at least one rubber,
D) at least one terpolymer, obtainable from
d1) at least one vinylaromatic monomer,
d2) at least one C₁-C₄-alkyl (meth)acrylate or (meth)acrylonitrile, and
d3) from 0.4 to 4% by weight, based on the total weight of components d1) to
d3), of at least one monomer in which an (α,β-unsaturated anhydride is present, and
E) at least one compound having at least two isocyanate groups.

2. A thermoplastic molding composition as claimed in claim 1, in which the proportion of component D is from 0.4 to 30% by weight, based on the total weight of components A to E.

3. A thermoplastic molding composition as claimed in claim 1, in which the proportion of component E is from 0.1 to 5% by weight, based on the total weight of components A to E.

4. A thermoplastic molding composition as claimed in claim 1, comprising, as component A, at least one copolymer of a vinylaromatic monomer with (meth)acrylonitrile.

5. A thermoplastic molding composition as claimed in claim 1, comprising, as component B, at least one polyester or polyamide.

6. canceled

7. A molding, a film, or a fiber which comprises the thermoplastic molding composition as claimed in claim 1.

8. A process for improving the compatibility of a thermoplastic molding composition, comprising
A) at least one rubber-free copolymer in which no hydroxyl group, acid group, amino group, or anhydride group is present, based on at least one vinylaromatic monomer (a1) and at least one copolymer (a2),
B) at least one rubber-free polymer in which at least one hydroxyl group, acid group, or amino group is present,
C) from 3 to 50% by weight, based on the total weight of components A to E, of at least one rubber, which comprises mixing components A to C in the presence of
D) at least one terpolymer, obtainable from
d1) at least one vinylaromatic monomer,
d2) at least one C₁-C₄-alkyl (meth)acrylate or (meth)acrylonitrile, and
d3) from 0.4 to 4% by weight, based on the total weight of components d1) to d3), of at least one monomer in which an α,β-unsaturated anhydride is present, and
E) at least one compound having at least two isocyanate groups.

9. canceled

10. A compatibilizer for thermoplastic molding composition encompassing at least one rubber-free polymer in which at least one hydroxyl group, acid group, or amino group is present which comprises a mixture of at least one terpolymer D obtainable from
d1) at least one vinylaromatic monomer,
d2) at least one C₁-C₄-alkyl (meth)acrylate or (meth)acrylonitrile, and
d3) from 0.4 to 4% by weight, based on the total weight of components d1) to d3), of at least one monomer in which an α,β-unsaturated anhydride is present, and at least one compound E having at least two isocyanate groups.

11. A thermoplastic molding composition as claimed in claim 2, in which the proportion of component E is from 0.1 to 5% by weight, based on the total weight of components A to E.

12. A thermoplastic molding composition as claimed in claim 11, comprising, as component A, at least one copolymer of a vinylaromatic monomer with (meth)acrylonitrile.

13. A thermoplastic molding composition as claimed in claim 12, comprising, as component B, at least one polyester or polyamide.

14. A molding, a film, or a fiber which comprises the thermoplastic molding composition as claimed in claim 13.
